(19) United States
(12) Patent Application Publication
(10) Pub. No.: US 2019/0217553 A1
(43) Pub. Date: Jul. 18, 2019

(54) Method for making phase change material products and system therefor

(71) Applicant: Peter Franz Horwath, New London, NC (US)

(72) Inventor: Peter Franz Horwath, New London, NC (US)

(21) Appl. No.: 15/790,627

(22) Filed: Oct. 23, 2017

Related U.S. Application Data
(60) Provisional application No. 62/385,995, filed on Sep. 10, 2016.

(51) Int. Cl. B29C 67/24; B29C 67/00; B01F 3/12; C09K 5/06; B32B 33/00

(52) U.S. Cl. CPC B29C 67/24; B29C 67/0011; B01F 3/1214; B29C 2791/004; B32B 33/00; B01F 2003/1278; C09K 5/06

(57) ABSTRACT

A method for processing phase change material includes providing pieces of phase change material having a transition temperature, the pieces of phase change material being in a solid phase. A medium is provided which is transformable from a liquid state to a solid state, the medium is in the liquid state and at a temperature which is below the transition temperature of the pieces of phase change material. The pieces of phase change material are combined with the medium to form a mixture. The mixture is supplied to a tool which forms a phase change material product. The medium is then transformed to the solid state.

### CROSS REFERENCE TO RELATED APPLICATION

This application claims the filing benefit under 35 U.S.C. § 119(e) of U.S. Provisional Application No. 62/385,995, filed Sep. 10, 2017, which is hereby incorporated by reference.

### TECHNICAL FIELD

The present invention pertains generally to phase change material, and in particular to a method and system for producing phase change material products.

### BACKGROUND OF THE INVENTION

The use of phase change material (PCM) to cool and heat air is well known in the art. PCM is a material which changes from one phase (e.g. liquid) to another phase (e.g. solid) at a specific transition temperature. PCM's have a high heat of fusion, and as such are capable of absorbing and releasing large amounts of energy. PCMs absorb heat from the environment when they “melt” (liquefy), and release heat into the environment when they “freeze” (solidify). PCMs can therefore serve as a temperature moderator which reduces temperature extremes. PCMs are available with a phase change temperature in the human comfort zone (e.g. around 75° F.).

PCMs are available with a variety of chemical compositions and transition temperatures, as is well know in the art. For example, inorganic/mineral based PCMs such as salt hydrates use salt, clay and water mix normally consisting of calcium chloride among other salt/chemical combinations. The transition temperatures of common salt hydrate PCM's are—45° F., 55° F., 65° F., 71° F., 73° F., and 78° F. Other types of PCMs are organic materials, petroleum or plant based and use oils/waxes such as paraffin, palm oil, fatty esters etc.

Sheets, coatings and products containing phase change materials have been used for years to increase comfort, reduce energy consumption, reduce temperature swings for buildings packaging and provide energy storage. Phase change materials (PCMs) absorb heat as they melt, changing phase from solid to liquid; and release heat as the material begins to freeze back to a solid state. Because PCMs transition for solid to liquid and back during normal use, the PCMs must be contained within the product to prevent leaking during the liquid phase. Currently manufactures of these products use expensive, complex processes such as micro encapsulation, self-encapsulation and macro encapsulation to contain the PCMs. These processes are expensive, denigrate the thermal properties of the PCMs and limit the applications of these materials.

### BRIEF SUMMARY OF THE INVENTION

The present invention is directed to a method and system for making phase change material products. The invention eliminates the necessity for pre-encapsulation by using a medium itself as the encapsulate. This can be accomplished by performing the mixing, forming and curing process at temperatures below the transition temperature of the phase change materials used therefore allowing the phase change materials to be handled in the solid phase and encapsulated by the medium used in the process

The above is a low cost method of integrating phase change materials into products without the need for micro encapsulation, macro encapsulation, or self-encapsulation. This can be done in a manufacturing line process, as an addition to a casting product or as an applied coating done within or outside of a manufacturing environment.

In one embodiment, the process is as follows:

1. A phase change materials is brought down below the melting temperature of the PCM and formed into the desired shape for inclusion into the final product. In most cases this would include cutting or grinding the frozen PCM to form PCM pieces of the correct size, however the product could be precast prior to freezing to the final shape.

2. The PCM pieces are mixed with a medium while the medium is below the PCM melting temperature and the medium is in its liquid state. That is, the medium is a substance which surrounds the PCM pieces to form a slurry mixture.

3. The combined mixture is formed (shaped) through any of multiple forming processes to the desired final shape. These processes could include but are not limited to: cold forming, extruding, roll forming etc.

4. The final product is allowed to cure (the medium solidify) at a temperature below the melting temperature of the phase change material. This temperature could be maintained by: keeping the environment below the temperature, by active cooling of the manufacturing surfaces, by addition of an evaporating component which would remove heat, by an endothermic reaction or any other method. Curing maybe by any method including UV activation, solvents or any other method to transition to a solid state.

Other embodiments, in addition to the embodiments enumerated above, will become apparent from the following detailed description, taken in conjunction with the accompanying drawings, which illustrate, by way of example, the principles of the method and system for making phase change material products.

### BRIEF DESCRIPTION OF THE DRAWINGS

FIG. 1 is a side elevation view of a system for making phase change material products;

FIG. 2 is an enlarged view of area 2 of FIG. 1;

FIG. 3 is an enlarged view of area 3 of FIG. 1;

FIG. 4 is a perspective view of a phase change material product;

FIG. 5 is an enlarged side elevation view of a first layer of medium;

FIG. 6 is an enlarged side elevation view of a phase change material product disposed on the first layer of medium;

FIG. 7 is an enlarged side elevation view of a second layer of medium disposed on the phase change material product;

FIG. 8 is a side elevation view of a sealed phase change material product;

FIG. 9 is a side elevation view of a second embodiment of the system for making phase change material products;

FIG. 10 is a side elevation view of a third embodiment of the system for making phase change material products;

FIG. 11 is an enlarged top plan view of a tool which is an extrusion die;

FIG. 12 is an enlarged perspective view of a mass of phase change material being ground to form pieces of phase change material;

FIG. 13 is an enlarged view of a compressible material added to a mixture of phase change material pieces and a medium; and,

FIG. 14 is an enlarged view of a porous material added to a mixture of phase change material pieces and a medium.

### DETAILED DESCRIPTION OF THE INVENTION

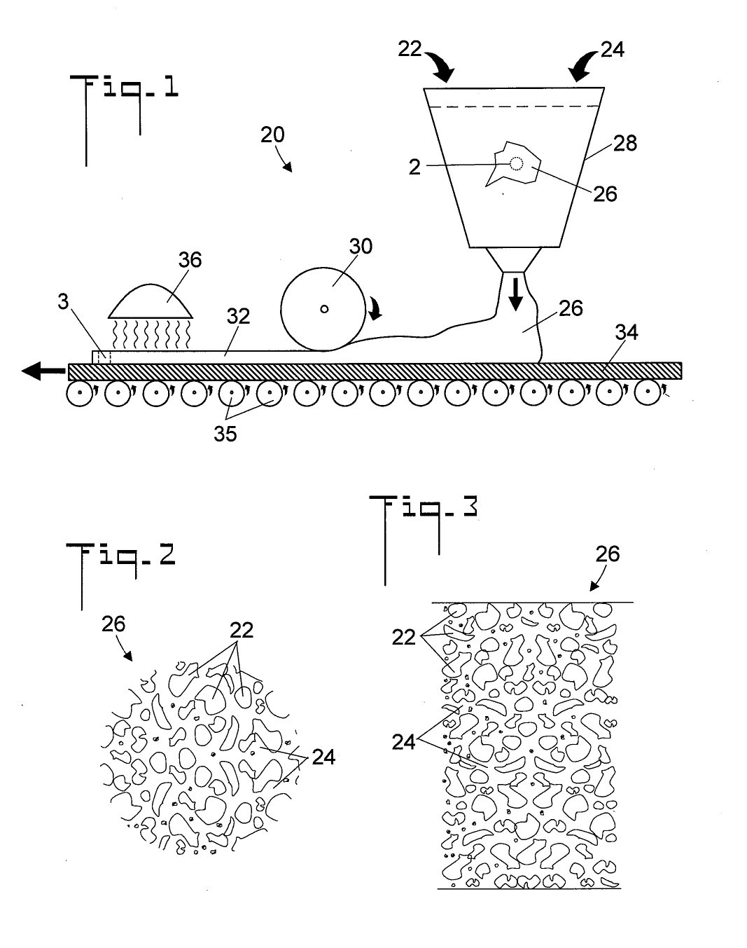

Referring initially to FIG. 1, there is illustrated a side elevation view of a manufacturing system for making phase change material products. generally designated as 20. FIG. 2 is an enlarged view of area 2 of FIG. 1, and FIG. 3 is an enlarged view of area 3 of FIG. 1. System 20 includes pieces of phase change material 22 which have a transition temperature, the pieces of phase change material 22 being in a solid (“frozen”) phase. Depending upon the application, the pieces of phase change material 22 can be of sizes ranging from a fine powder to chunks having a maximum dimension of one inch or more. The shape of the pieces of phase change material 22 can be irregular as shown, or can be pellets, grains, spheres, strings, rods, fibers, or any other useful form.

The pieces of phase change material 22 can be formed by grinding, shaving, shredding, cutting, extruding, casting, pelletizing, or the like (refer to FIG. 12 and the associated discussion for one embodiment). The pieces of phase change material 22 are keep in the solid phase by maintaining the surrounding environment at a temperature which is below the transition temperature of the pieces of phase change material 22. This can be accomplished controlling the temperature of (1) the ambient air, (2) the working surfaces which contact the pieces of phase change material 22, (3) the medium (see discussion below), (4) the tool (see discussion below), or a combination of these.

System 20 further includes a medium 24 which is transformable from a liquid state to a solid state, the medium 24 initially being in the liquid state and at a temperature which is below the transition temperature of the pieces of phase change material 22. While in the liquid state, medium 24 is configured to combine with the pieces of phase change material 22 to form a mixture 26 (i.e. a slurry of pieces of phase change material 22 and medium 24). The mixing is performed in a vessel 28. Later, the medium 24 can be transformed to the solid state and thereby encapsulate the pieces of phase change material 22. Medium 22 can be a polymer, epoxy, resin, paint, or the like which is in the liquid state when mixed with the pieces of phase change material 22, and can then be permanently transformed to the solid state by UV activation, solvent evaporation, drying, or the like.

System 20 further includes a tool 30 which is configured to receive mixture 26 and form (create) a phase change material product 32 of a desired shape and size. That is, tool 30 can be any device which is designed to form a phase change material product 32 from mixture 26 (e.g. tool 30 can be a roller, a sprayer, a mold, a container, a bag, a brush, a pouring vessel, a die, an extrusion die, etc.). In an embodiment, tool 30 is at a temperature which is below the transition temperature of the pieces of phase change material 22. Phase change material product 32 can be a panel, a sheet, a film, a coating, strands, fibers, a casting, or any other desired shape. In the shown embodiment, phase change material product 32 is a sheet, and tool 30 includes a roller which is configured to roll mixture 26 into the sheet. The shown embodiment also includes a movable support surface 34 which receives mixture 26 and moves it into the roller. Movable support surface 34 rolls on rollers 35. In the shown embodiment, after rolling into a sheet a UV light 36 transforms (cures) the medium 24 of mixture 26 to the solid state, thereby resulting in a sheet of pieces of phase change material 22 surrounded by solid state medium 24. Phase change material product 32 can also be sealed to prevent leakage of liquid phase change material 22 (refer also to FIGS. 5-8 and the associated discussions). After the medium 24 has been transformed to the solid state, phase change material product 32 can be raised to a temperature above the transition temperature.

Referring to FIGS. 2 and 3, in mixture 26 the weight percent of pieces of phase change material 22 can vary depending upon the application (e.g. 10%-90%). In an embodiment the weight percent is at least 0.50%

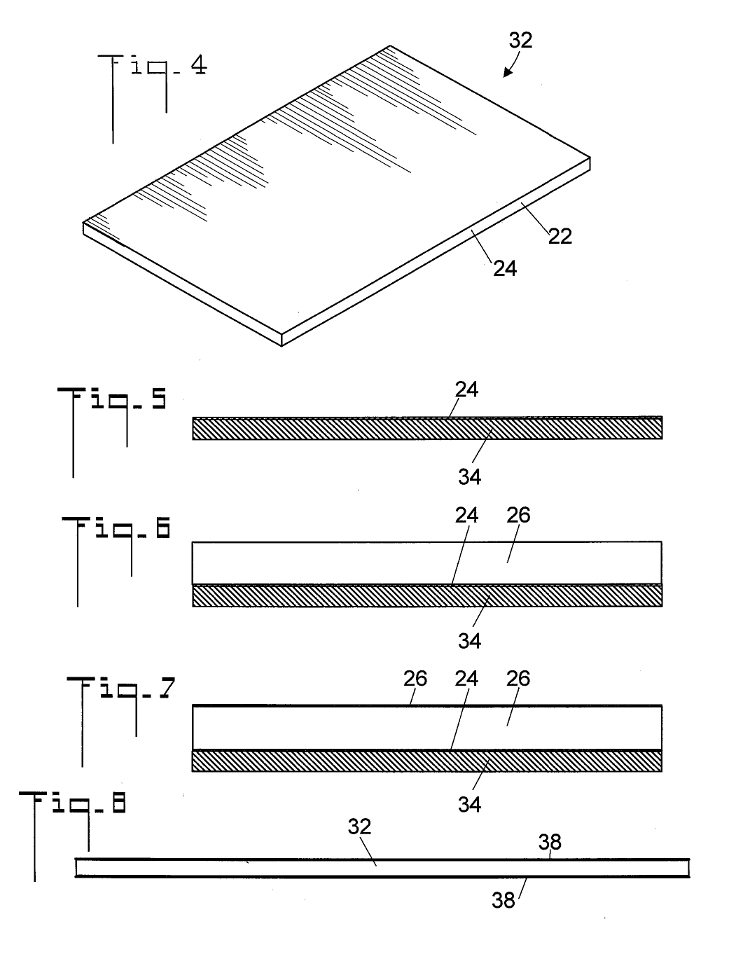

FIG. 4 is a perspective view of a phase change material product 32. In the shown embodiment phase change material product 32 is a sheet of phase change material 22 encased in solid medium 24.

FIGS. 5-7 illustrate a sequence of sealing mixture 26 with two layers of medium 24 to form a sealed phase change material product 32. That is, phase change material product 32 includes a layer of mixture 26 sandwiched between first and second layers of medium 24. Each layer is sequentially deposited. Sealing prevents pieces of phase change material 22 from leak due to expansion (refer also to FIG. 13 and the associated discussion). In an embodiment the medium 24 of each layer is transitioned to the solid state prior to the application of the next layer. In the shown embodiment, a support surface 34 is used to hold the layers during construction. The sealing can be performed using the apparatus of FIG. 1, or the medium 24 can be painted, sprayed, or applied in any other effective manner.

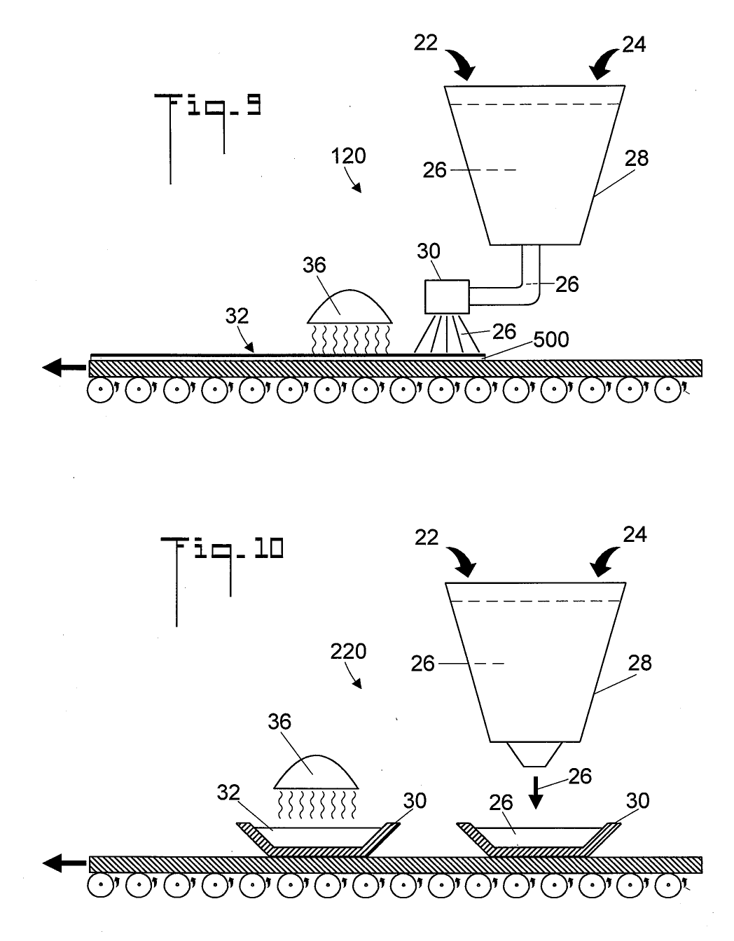

FIG. 8 is a side elevation view of a sealed phase change material product 32. A sealer 38 seals phase change material product 32 to both protect the product and prevent phase change material leaks. Sealer 38 can be a paint, a layer of polymer or other material, a layer of medium, or any other covering which will seal and protect phase change material product 32. Sealer may be applied by any useful means such as by spraying, with a brush, wiped, poured, etc.

FIG. 9 is a side elevation view of a second embodiment of the system for making phase change material products 32, generally designated as 120. Pieces of phase change material 22 are combined with a medium 24 in a vessel 28. The resulting mixture 26 is transferred to a tool 30 which in this instance is a sprayer which is configured to spray mixture 26 onto an article 500 (such as the shown thin sheet) to form a coating on the article 500. In this embodiment the phase change material product 32 is the coating which is applied to the article 500. As with FIG. 1, a UV light 36 is then used to harden the medium 24.

FIG. 10 is a side elevation view of a third embodiment of the system for making phase change material products 32, generally designated as 220. As before pieces of phase change material 22 are combined with a medium 24 in a vessel 28. The resulting mixture 26 is transferred to tool 30 which in this instance is a mold into which mixture 26 can be poured. The mold may be that of any traditional casting process. In this instance the phase change material product 32 is the casting which is formed by the mold. As with FIGS. 1 and 9, a UV light 36 is then used to harden the medium 24.

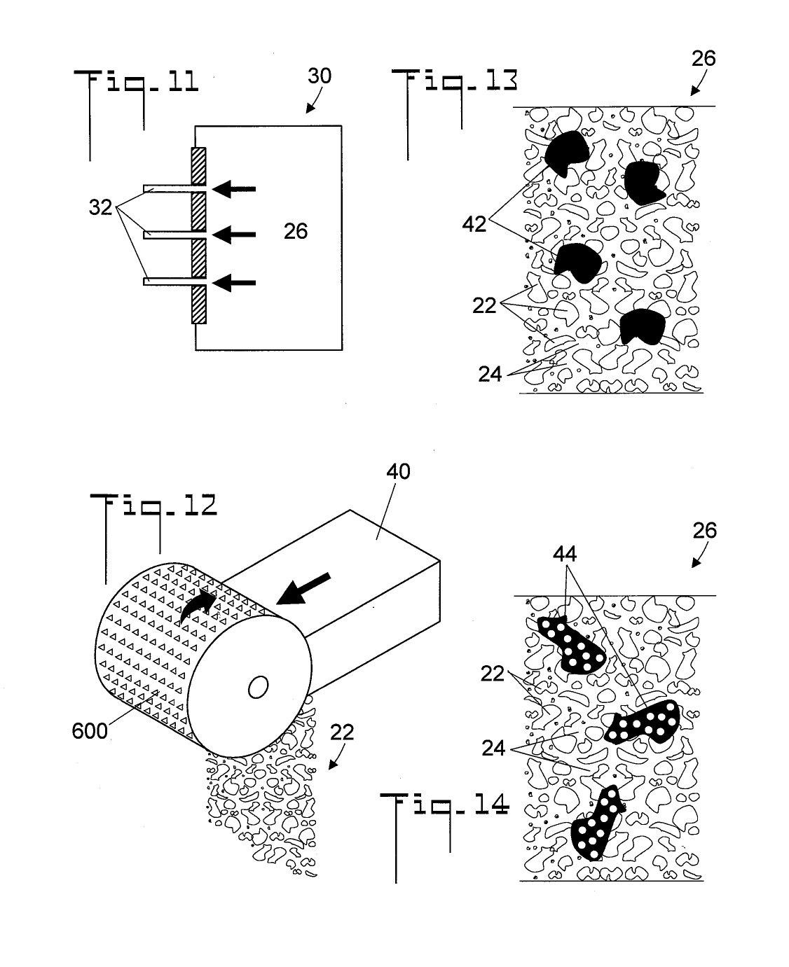

FIG. 11 is an enlarged top plan view of a tool 30 which is an extrusion die. Mixture 26 is forced out through apertures in the extrusion die to form phase change material product 32 (such as the shown strands).

FIG. 12 is an enlarged perspective view of a mass of phase change material 40 being ground to form pieces of phase change material 22. In the shown embodiment a grinder 600 is used to form the pieces of phase change material 22. Mass of phase change material 40 is in the solid phase, and the pieces of phase change material 22 are formed from the mass. It may be appreciated that mass of phase change material 40 could be the shown block, a lump, a chunk, a sheet, or other form.

FIG. 13 is an enlarged view of a compressible material 42 (such as foam) added to the mixture 26 of pieces of phase change material 22 and a medium 24. It is noted that after medium 24 is transformed to the solid state, the pieces of phase change material 22 are closely surrounded by the hardened medium 24. As such a problem can occur when the pieces of phase change material 22 are heated above the transition temperature and melt (change to the liquid phase). During melting the phase change material pieces 22 will expand, and thereby induce stresses in the solid medium 24. If large enough these stress could cause cracking of the medium 24. Compressible material 42 mitigates this effect by absorbing expansion as it occurs. Another way of lessening stresses is to add a porous material to mixture 26 (refer to FIG. 14 and the associated discussion). Other methods of stress reduction include (1) using a medium 24 which is slightly flexible when in the solid state, (2) reduce the particle size of the pieces of phase change material 22 to reduce the expansion effect, and (3) heating the mixture 26 above the transition temperature during the transition of the medium 24 to the solid state. That is, heating the mixture 26 once the medium 24 has setup but has not yet fully be transformed to the solid state, thereby allowing for expansion of the pieces of phase change material 22 without causing stress.

FIG. 14 is an enlarged view of a porous material 44 added to the mixture 26 of pieces of phase change material 22 and the medium 24. Porous material 44 absorbs the phase change material as it expands and thereby reduces expansion-related stresses.

In terms of use, a method for processing phase change material includes:

(a) providing pieces of phase change material 22 having a transition temperature, the pieces of phase change material 22 being in a solid phase;

(b) providing a medium 24 which is transformable from a liquid state to a solid state, the medium 24 being in the liquid state and at a temperature which is below the transition temperature of the pieces of phase change material 22;

(c) combining the pieces of phase change material 22 with the medium 24 to form a mixture 26;

(d) providing a tool 30;

(e) transferring the mixture 26 to the tool 30;

(f) using the tool 30 to form a phase change material product 32;

(g) transforming the medium 24 to the solid state; and,

during (c), (e), and (f) the pieces of phase change material 22 being in the solid phase.

The method further including:

in (a), providing a mass 40 of phase change material which is in the solid phase; and,

creating the pieces of phase change material 22 from the mass of phase change material 40.

The method further including:

in (f), the phase change material product 32 being a sheet; and,

in (d), the tool 30 including a roller which is configured to roll the mixture 24 into the sheet.

The method further including:

providing a support surface 34;

prior to (f), depositing a layer of medium 24 upon the support surface 34 and transforming the layer of medium 24 to the solid state;

in (f), the phase sensitive material product 32 being depositing on the layer of medium 24; and,

after (g), depositing a second layer of the medium 24 upon the phase change material product 32 and transforming the second layer of medium 24 to the solid state.

The method further including:

in (f), the phase change material product 32 being a coating;

providing an article 500; and,

in step (d), the tool 30 including a sprayer which is configured to spray the mixture 24 onto the article 500 to form the coating.

The method further including:

in (f), the phase change material product 32 being a casting; and,

in (d), the tool 30 including a mold into which the mixture 24 is pourable.

The method further including:

providing a sealer 38; and,

prior to (g), using the sealer 38 to seal the phase sensitive material product 32.

The method further including:

in (d), the tool 30 including an extrusion die.

The method further including:

during (c), adding a compressible material 42 to the mixture.

The method further including:

during (c), adding a porous material 44 to the mixture.

As applicable the order of performance of the above cited method steps can be changed.

The method further including:

during (g), said pieces of phase change material 22 being in said solid phase.

The method further including:

during (g), raising a temperature of said mixture 26 above said transition temperature.

The embodiments of the method and system for making phase change material products described herein are exemplary and numerous modifications, combinations, variations, and rearrangements can be readily envisioned to achieve an equivalent result, all of which are intended to be embraced within the scope of the appended claims. Further, nothing in the above-provided discussions of the method and system should be construed as limiting the invention to a particular embodiment or combination of embodiments. The scope of the invention is defined by the appended claims.

I claim:

1. A method for processing phase change material, comprising:
(a) providing pieces of phase change material having a transition temperature, said pieces of phase change material being in a solid phase;
(b) providing a medium which is transformable from a liquid state to a solid state, said medium being in said liquid state and at a temperature which is below said transition temperature of said pieces of phase change material;
(c) combining said pieces of phase change material with said medium to form a mixture;
(d) providing a tool;
(e) transferring said mixture to said tool;
(f) using said tool to form a phase change material product;
(g) transforming said medium to said solid state; and, during (c), (e), and (f) said pieces of phase change material being in said solid phase.

2. The method of claim 1, further including:
in (a), providing a mass of phase change material which is in said solid phase; and,
creating said pieces of phase change material from said mass of phase change material.

3. The method of claim 1, further including:
in (f), said phase change material product being a sheet; and,
in (d), said tool including a roller which is configured to roll said mixture into said sheet.

4. The method of claim 1. further including:
providing a support surface;
prior to (f), depositing a layer of medium upon said support surface and transforming said layer of medium to said solid state;
in (f), said phase sensitive material product being depositing on said layer of medium; and,
after (g), depositing a second layer of said medium upon said phase change material product and transforming said second layer of medium to said solid state.

5. The method of claim 1, further including:
in (f), said phase change material product being a coating;
providing an article; and,
in (d), said tool including a sprayer which is configured to spray said mixture onto said article to form said coating.

6. The method of claim 1, further including:
in (f), said phase change material product being a casting; and,
in (d), said tool including a mold into which said mixture is pourable.

7. The method of claim 6, further including:
providing a sealer; and,
prior to (g), using said sealer to seal said phase sensitive material product.

8. The method of claim 1, further including:
in (d), said tool including an extrusion die.

9. The method of claim 1, further including:
during (c), adding a compressible material to said mixture.

10. The method of claim 1, further including:
during (c), adding a porous material to said mixture.

11. The method of claim 1, further including:
during (g), said pieces of phase change material being in said solid phase.

12. The method of claim 1, further including:
during (g), raising a temperature of said mixture above said transition temperature.

13. A manufacturing system, comprising:
pieces of phase change material having a transition temperature, said pieces of phase change material being in a solid phase;
a medium which is transformable from a liquid state to a solid state, said medium being in said liquid state and at a temperature which is below said transition temperature of said pieces of phase change material, said medium configured to combine with said pieces of phase change material to form a mixture; and,
a tool which is configured to receive said mixture and form a phase change material product.

14. The system of claim 13, further including:
said phase change material product being a sheet; and,
said tool including a roller which is configured to roll said mixture into said sheet.

15. The system of claim 13, further including:
an article;
said phase change material product being a coating; and
said tool including a sprayer which is configured to spray said mixture onto said article to form said coating.

16. The system of claim 13, further including:
said tool including a mold into which said mixture is pourable.

17. The system of claim 13, further including:
a mass of phase change material which is in said solid phase; and,
said pieces of phase change material formed from said mass of phase change material.

18. The system of claim 13, further including:
said phase change material product including a layer of said mixture sandwiched between first and second layers of said medium.

19. The system of claim 13, further including:
a sealer which is configured to seal said phase sensitive material product.

20. The system of claim 13, further including:
said tool including an extrusion die.

21. The system of claim 13, further including:
said mixture including a compressible material.

22. The system of claim 13, further including:
said mixture including a porous material.
